(19) United States
(12) Patent Application Publication
(10) Pub. No.: US 2009/0157783 A1
(43) Pub. Date: Jun. 18, 2009

(54) NUMERICALLY-CONTROLLED OSCILLATOR CAPABLE OF GENERATING COSINE SIGNAL AND SINE SIGNAL ONLY USING COSINE LOOK UP TABLE AND OPERATING METHOD OF THE NUMERICALLY-CONTROLLED OSCILLATOR

(75) Inventors: Seok SEO, Daejeon (KR); Min Joung SHEEN, Daejeon (KR); Gweon Do JO, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/237,832

(22) Filed: Sep. 25, 2008

(30) Foreign Application Priority Data
Dec. 17, 2007 (KR) 10-2007-0132830

(51) Int. Cl. G06F 1/02

(52) U.S. Cl. 708/276

(57) ABSTRACT

A numerically-controlled oscillator (NCO) and an operating method of the NCO are provided. According to the NCO and the operating method of the NCO, it is possible to reduce the size of a lookup table memory by using a lookup table, which stores a plurality of phase compensation values for different phases obtained by using a cosine function or a sine function. Thus, it is possible to easily calculate cosine and sine addresses and cosine and sine signs and to quickly provide a cosine phase compensation signal and a sine phase compensation signal.

This application claims the benefit of Korean Application No. 2007-0132830, filed on Dec. 17, 2007 in the Korean Intellectual Property Office, the disclosure of which is incorporated herein by reference.

### BACKGROUND OF THE INVENTION

1. Field of the Invention

The present invention relates to a numerically-controlled oscillator (NCO), which can reduce the size of a lookup table memory by extracting a cosine phase compensation signal and a sine phase compensation signal from a lookup table that stores various phase compensation values for different phases obtained by using either a cosine function or a sine function, and an operating method of the NCO.

The present invention is based on research (Project No.: 2006-S-001-02, Project Title: Development of Adaptive Wireless Access and Transmission Technology for Fourth Generation Mobile communication) conducted as part of Information Technology (IT) Growth Power Technology Development Project launched by Ministry of Information and Communication and Institute for Information Technology Advancement (IITA).

2. Description of the Related Art

Numerically-controlled oscillators (NCOs) are digital counterparts of voltage-controlled oscillators (VCOs), which are analog devices. NCOs receive multi-bit numeric values, instead of voltages, as input data and thus provide almost the same functions as those of VCOs.

That is, NCOs may be configured as digital circuits in order to address the problems associated with analog VCOs, which are highly likely to deteriorate due to temperature variations, are relatively difficult to control, and provide low integration density.

FIG. 1 illustrates a block diagram of a conventional NCO 9. Referring to FIG. 1, the conventional NCO 9 includes an address generator 2, which determines an address cf for a cosine function and an address sf for a sine function based on the phase θ of an input signal, a lookup table memory 5, which includes a cosine lookup table 3 and a sine lookup table 4, and an output format unit 6, which outputs the cosine phase compensation value and the sine phase compensation value as a cosine phase compensation signal cosθ and a sine phase compensation signal sinθ, respectively, according to a number of setting conditions. The cosine lookup table 3 stores a cosine phase compensation value for the cosine function, and the sine lookup table 4 stores a sine phase compensation value for the sine function.

The cosine lookup table 3 and the sine lookup table 4 have an m-bit phase resolution and an n-bit amplitude resolution.

The cosine lookup table 3 and the sine lookup table 4 may be represented by Equation (1):

sin(i)=round_off[(2ⁿ−1)cos(2π(i+0.5)/2^{m})]

cos(i)=round_off[(2ⁿ−1)cos(3π(i+0.5)/2^{m})] (1)

where i=0, 1, 2, . . . , 2^{m}−1 and round_off[ ] is a function for rounding a value to the closest integer greater than the original value.

In order to realize the cosine lookup table 3 and the sine lookup table 4, which have an m-bit phase resolution and an n-bit amplitude resolution, the lookup table memory 5 may be required to have a storage capacity of 2^{m+1}×n bits.

Therefore, the conventional NCO 9 can only be used in a lookup table memory having a 2^{m}-bit storage capacity.

### SUMMARY OF THE INVENTION

The present invention provides a numerically-controlled oscillator (NCO), which can reduce the size of a lookup table memory by extracting a cosine phase compensation signal and a sine phase compensation signal from a lookup table that stores various phase compensation values for different phases obtained by using either a cosine function or a sine function, and an operating method of the NCO.

According to an aspect of the present invention, there is provided an NCO including a lookup table memory which stores a plurality of phase compensation values for different phases; an address generator which calculates a number of addresses and a number of signs corresponding to an input phase; and a sign converter which converts the signs of a number of phase compensation values respectively corresponding to the addresses with reference to the signs.

According to another aspect of the present invention, there is provided an operating method of an NCO, the operating method including setting a plurality of phase compensation values for different phases; calculating a number of addresses and a number of signs corresponding to an input phase; and converting the signs of a number of phase compensation values respectively corresponding to the addresses with reference to the signs.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram of a conventional numerically-controlled oscillator (NCO);

FIG. 2 illustrates a block diagram of a phase locked loop (PLL) according to an embodiment of the present invention;

FIG. 3 illustrates a block diagram of a digital frequency locked loop according to an embodiment of the present invention;

FIG. 4 illustrates a block diagram of an NCO according to an embodiment of the present invention;

FIG. 5 illustrates a table showing various cosine addresses for different phases and the signs of the various cosine addresses;

FIG. 6 illustrates a table showing various sine addresses for different phases and the signs of the various sine addresses; and

FIG. 7 illustrates a flowchart of an operating method of an NCO according to an embodiment of the present invention.

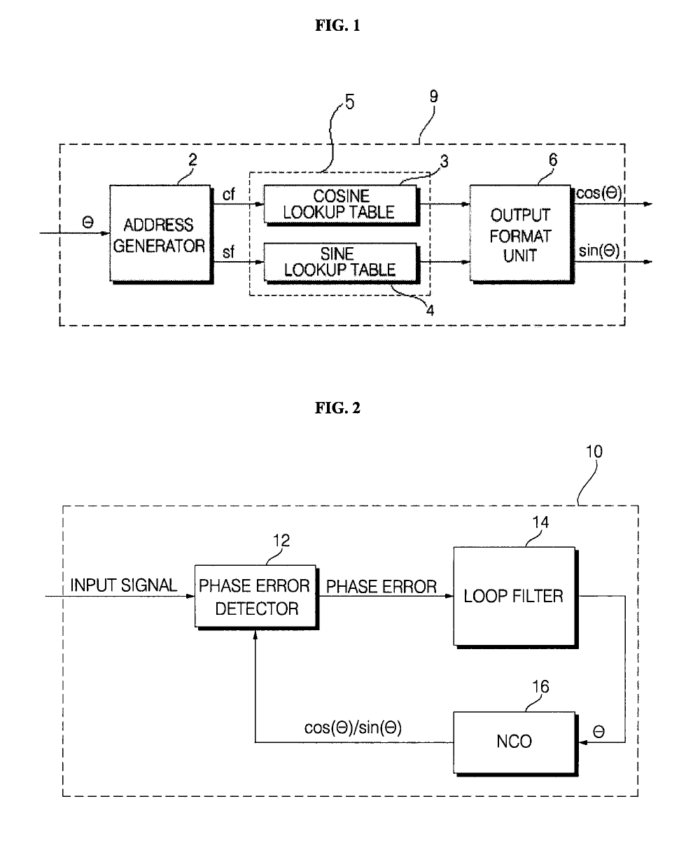

### DETAILED DESCRIPTION OF THE INVENTION

The present invention will hereinafter be described in detail with reference to the accompanying drawings in which exemplary embodiments of the invention are shown.

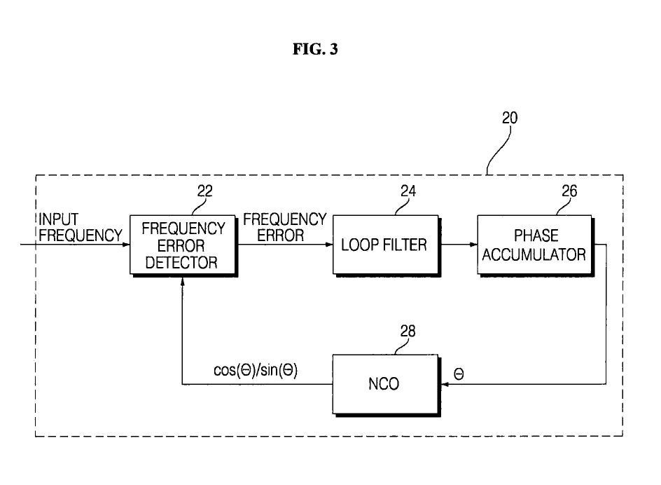

FIG. 2 illustrates a block diagram of a phase locked loop (PLL) 10 according to an embodiment of the present invention, and FIG. 3 illustrates a block diagram of a digital frequency locked loop 20 according to an embodiment of the present invention.

Referring to FIG. 2, the PLL 10 includes a phase error detector 12, a loop filter 14 and a numerically-controlled oscillator (NCO) 16.

The phase error detector 12 mixes an input signal and a compensation signal provided by the NCO 16 and detects a phase error using a signal obtained by the mixing.

The loop filter 14 performs loop filtering on the phase error detected by the phase error detector 12 and thus provides a phase with an improved signal-to-noise ratio (SNR).

The NCO 16 generates the compensation signal, which includes a cosine phase compensation signal and a sine phase compensation signal, using a look up table which stores various phase compensation values for different phases, and outputs the compensation signal to the phase error detector 12.

The compensation signal output by the NCO 16 is fed back to the phase error detector 12 and is thus used to compensate for the phase error detected by the phase error detector 12.

Referring to FIG. 3, the digital frequency locked loop 20 includes a frequency error detector 22, a loop filter 24, a phase accumulator 26 and an NCO 28.

The frequency error detector 22 may detect a frequency error by mixing an input frequency and a compensation signal provided by the NCO 28.

The loop filter 24 performs loop filtering on the frequency error detected by the frequency error detector 22 and thus provides a phase with an improved SNR.

The phase accumulator 26 accumulates the phase provided by the loop filter 24 and outputs the accumulated phase.

The NCO 16 generates a compensation signal, which includes a cosine phase compensation signal and a sine phase compensation signal, using a lookup table, which stores various phase compensation values for different phases output by the phase accumulator 26, and outputs the compensation signal to the frequency error detector 22.

Therefore, the compensation signal is fed back to the phase error detector 12, and thus, the frequency error detected by the frequency error detector 22 may be compensated for.

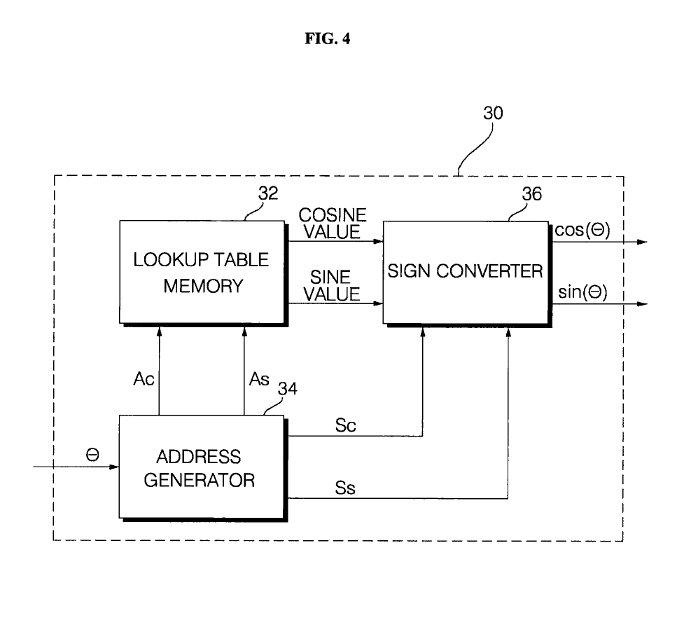

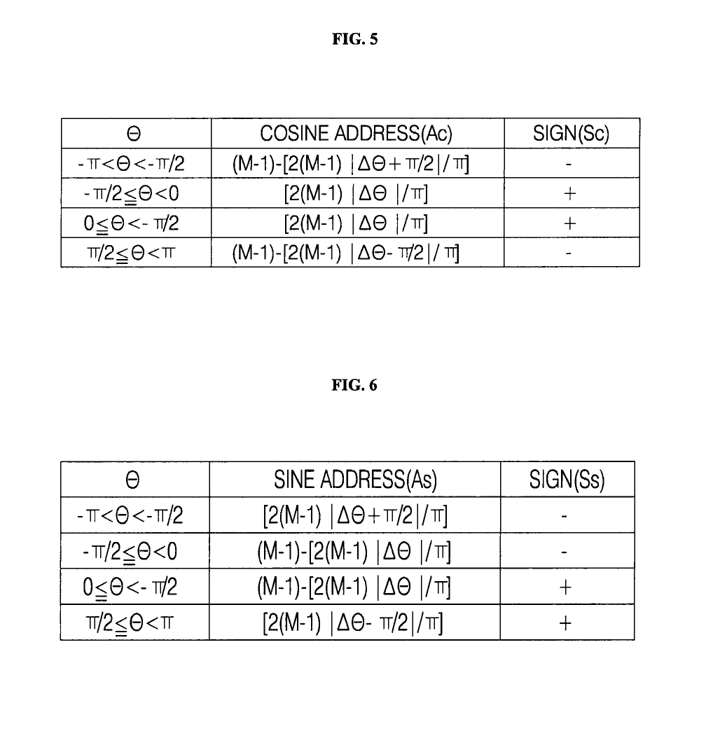

FIG. 4 illustrates a block diagram of an NCO 30 according to an embodiment of the present invention, FIG. 5 illustrates a table showing various cosine addresses for different phases and the signs of the various cosine addresses, and FIG. 6 illustrates a table showing various sine addresses for different phases and the signs of the various sine addresses.

Referring to FIG. 4, the NCO 30 includes a lookup table memory 32, which stores various phase compensation values for different phases, an address generator 34, which calculates addresses Ac and As corresponding to a phase θ of an input signal and signs Sc and Ss corresponding to the phase θ, and a sign converter 36 which converts the sign of the phase compensation value according to the signs Sc and Ss.

The lookup table memory 32, the address generator 34 and the sign converter 36 may be incorporated into one or more devices, or each of the lookup table memory 32, the address generator 34 and the sign converter 36 may be divided into two or more units.

The lookup table memory 32 stores various phase compensation values for different phases. That is, the lookup table memory 32 may store a lookup table that calculates various phase compensation values for different phases using the periodicity of a cosine or sine function, i.e., the periodicity of a trigonometrical function.

The lookup table may store a plurality of phase compensation values obtained by only using a cosine function or only using a sine function.

The lookup table may store a plurality of phase compensation values for respective corresponding phases within one fourth of a period.

The lookup table memory 32 may output a phase compensation value corresponding to the address Ac and a phase compensation value corresponding to the address As with reference to the lookup table, which has an n-bit amplitude resolution.

That is, if the size of lookup table memory 32 is M, the size of the lookup table may be calculated by using Equation (2):

cos(i)=round_off[(2ⁿ−1)cos(0.5π(i+0.5)/(M−1)] (2)

where i=0, 1, 2, . . . , M−1 and round_off[ ] is a function for rounding a value to the closest integer greater than the original value.

Referring to Equation (2), the phase compensation values corresponding to the addresses Ac and As may be determined by a cosine function, and the size of the lookup table may be determined by an n-bit amplitude resolution.

The size of a lookup table according to the present invention and the size of a conventional lookup table will hereinafter be described in detail with reference to Equations (1) and (2).

Referring to Equation (2), the size of a lookup table according to the present invention is determined by an n-bit amplitude resolution. On the other hand, referring to Equation (1), the size of a conventional lookup table is determined by an m-bit phase resolution and an n-bit amplitude resolution.

Therefore, the size of a lookup table according to the present invention may be smaller than the size of a conventional lookup table.

The address generator 34 calculates the addresses Ac and As and the signs Sc and Ss based on the phase difference between a cosine function and a sine function.

The addresses Ac and As include a cosine address Ac of a phase compensation value obtained by a cosine function and a sine address As of a phase compensation value obtained by a sine function.

The signs Sc and Ss include a cosine sign Sc of the phase compensation value obtained by a cosine function and a sine sign Ss of the phase compensation value obtained by a sine function.

The address generator 34 may calculate the cosine and sine addresses Ac and As and the cosine and sine signs Sc and Ss based on the phase difference between a cosine function and a sine function, as indicated by Equation (3):

sin(θ)=cos(θ−π/2) (3)

where θ indicates the phase of an input signal.

That is, the address generator 34 may calculate the cosine and sine addresses Ac and As and the cosine and sine signs Sc and Ss, which correspond to the phase θ, based on the phase difference between a cosine function and a sine function, as indicated by Equation (3), by using the tables illustrated in FIGS. 5 and 6.

FIG. 5 illustrates a table of various cosine addresses (Ac) and various cosine signs (Sc) for different phase ranges (0) of an input signal, and FIG. 6 illustrates a table of various sine addresses (As) and various sine signs (Ss) for the different phase ranges (θ) of the input signal.

The cosine and sine addresses Ac and As and the cosine and sine signs Sc and Ss corresponding to the phase θ may be calculated by using the properties of a trigonometric function, as indicated by Equation (3).

The address generator 34 transmits the cosine and sine addresses Ac and As corresponding to the phase θ to the lookup table memory 32, and transmits the cosine and sine signs Sc and Ss corresponding to the phase θ to the sign converter 36.

If the phase θ is within the range of −π and −π/2, i.e., −π≦θ<−π/2, the address generator 34 may determine the cosine address Ac corresponding to the phase θ to be (M−1)−└2(M−1)|θ+π/2|/π┘, and determine the cosine sign Sc corresponding to the phase θ to be negative (−), as indicated by the table of FIG. 5. Then, the address generator 34 may determine the sine address As corresponding to the phase θ to be └2(M−1)|θ+π/2|/π┘, and determine the sine sign Sc corresponding to the phase θ to be negative (−), as indicated by the table of FIG. 6. Referring to the tables of FIGS. 5 and 6, └X┘ indicates the closest integer smaller than X.

In this manner, the address generator 34 can easily calculate the cosine and sine addresses Ac and As and the cosine and sine signs Sc and Ss corresponding to the phase θ by using the tables of FIGS. 5 and 6.

The sign converter 36 selectively converts the sign of the phase compensation value corresponding to the cosine address Ac or the sign of the phase compensation value corresponding to the sign address As with reference to the cosine and sine signs Sc and Ss according to a set of rules.

Therefore, the sign converter 36 may selectively convert the sign of the phase compensation value corresponding to the cosine address Ac into the cosine sign Sc and may thus provide a cosine phase compensation signal. In addition, the sign converter 36 may selectively convert the sign of the phase compensation value corresponding to the sine address As into the sine sign Ss and may thus provide a sine phase compensation signal.

The sign converter 36 may output the cosine and sine phase compensation signals to the phase error detector 12 of FIG. 2 or the frequency error detector 22 of FIG. 3.

The NCO 30 uses the lookup table memory 32, which includes a lookup table that stores a plurality of phase compensation values for different phases obtained by using either a cosine function or a sine function. Thus, it is possible to reduce the size of the lookup table and thus to reduce the size of the lookup table memory 32.

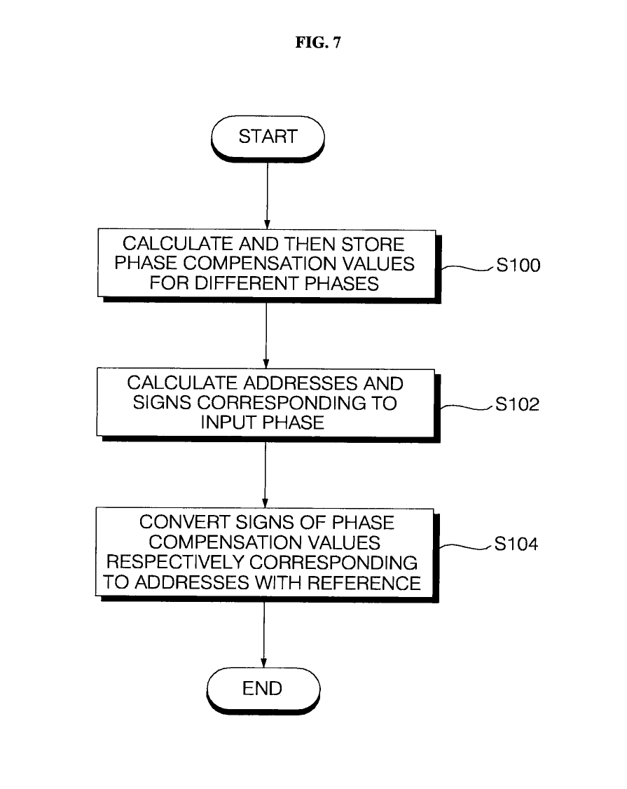

FIG. 7 illustrates a flowchart of an operating method of an NCO according to an embodiment of the present invention. Referring to FIG. 7, the NCO 30 is driven according to a filtered phase provided by a loop filter.

The lookup table memory 32 calculates a plurality of phase compensation values for different phases by using a cosine function or a sine function, and stores the calculated phase compensation values in a lookup table (S100).

The address generator 32 calculates cosine and sine addresses Ac and As and cosine and sine signs Sc and Ss corresponding to the phase θ of an input signal (S 102).

Thereafter, the address generator 32 outputs the cosine and sine addresses Ac and As to the lookup table memory 32 and outputs the cosine and sine signs Sc and Ss to the sign converter 36.

Then, the sign converter 36 receives two phase compensation values respectively corresponding to the cosine and sine addresses Ac and As and selectively converts the signs of the two phase compensation values with reference to the cosine and sine signs Sc and Sc, thereby providing a cosine phase compensation signal and a sine phase compensation signal.

As described above, according to the present invention, it is possible to reduce the size of a lookup table memory by using a lookup table, which stores a plurality of phase compensation values for different phases obtained by using a cosine function or a sine function. Thus, it is possible to easily calculate cosine and sine addresses and cosine and sine signs and to quickly provide a cosine phase compensation signal and a sine phase compensation signal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A numerically-controlled oscillator (NCO) comprising:
a lookup table memory which stores a plurality of phase compensation values for different phases;
an address generator which calculates a number of addresses and a number of signs corresponding to an input phase; and
a sign converter which converts the signs of a number of phase compensation values respectively corresponding to the addresses with reference to the signs.

2. The NCO of claim 1, wherein the lookup table memory calculates the phase compensation values for the different phases using the periodicity of a cosine function and stores the calculated phase compensation values.

3. The NCO of claim 1, wherein the lookup table memory calculates the phase compensation values for the different phases using the periodicity of a sine function and stores the calculated phase compensation values.

4. The NCO of claim 1, wherein the different phases are one fourth of a period.

5. The NCO of claim 1, wherein the address generator calculates the addresses and the signs based on the phase difference between a cosine function and a sine function.

6. The NCO of claim 1, wherein the sign converter converts the signs of the phase compensation values respectively corresponding to the addresses with reference to the signs according to a set of rules.

7. The NCO of claim 6, wherein the addresses comprise a cosine address of a phase compensation value corresponding to a cosine function and a sine address of a phase compensation value corresponding to a sine function.

8. The NCO of claim 7, wherein the signs comprise a cosine sign of a phase compensation value corresponding to the cosine address and a sine sign of a phase compensation value corresponding to the sine address.

9. The NCO of claim 8, wherein the sign converter generates a cosine phase compensation signal by converting the sign of the phase compensation value corresponding to the cosine address into the cosine sign, and generates a sine phase compensation signal by converting the sign of the phase compensation value corresponding to the sine address into the sine sign.

10. An operating method of an NCO, the operating method comprising:
setting a plurality of phase compensation values for different phases;
calculating a number of addresses and a number of signs corresponding to an input phase; and
converting the signs of a number of phase compensation values respectively corresponding to the addresses with reference to the signs.

11. The operating method of claim 10, wherein the setting comprises calculating the phase compensation values for the different phases using the periodicity of a cosine function and storing the calculated phase compensation values in a lookup table memory.

12. The operating method of claim 10, wherein the setting comprises calculating the phase compensation values for the different phases using the periodicity of a sine function and storing the calculated phase compensation values in a lookup table memory.

13. The operating method of claim 10, wherein the different phases are one fourth of a period.

14. The operating method of claim 10, wherein the calculating comprises calculating the addresses and the signs based on the phase difference between a cosine function and a sine function.

15. The operating method of claim 14, wherein the addresses comprise a cosine address of a phase compensation value corresponding to a cosine function and a sine address of a phase compensation value corresponding to a sine function.

16. The operating method of claim 15, wherein the signs comprise a cosine sign of a phase compensation value corresponding to the cosine address and a sine sign of a phase compensation value corresponding to the sine address.

17. The operating method of claim 16, wherein the converting comprises generating a cosine phase compensation signal by converting the sign of the phase compensation value corresponding to the cosine address into the cosine sign, and generating a sine phase compensation signal by converting the sign of the phase compensation value corresponding to the sine address into the sine sign.
